(19) United States
(12) Patent Application Publication
(10) Pub. No.: US 2024/0002089 A1
(43) Pub. Date: Jan. 4, 2024

(54) MECHANISM FOR PRECISELY FILLING CONTAINERS

(71) Applicant: Barry K. Jones, Carleton, MI (US)

(72) Inventor: Barry K. Jones, Carleton, MI (US)

(21) Appl. No.: 18/319,629

(22) Filed: May 18, 2023

Related U.S. Application Data
(60) Provisional application No. 63/367,533, filed on Jul. 1, 2022.

(51) Int. Cl. B65B 39/00; B65B 39/06

(52) U.S. Cl. CPC B65B 39/007; B65B 39/06

(57) ABSTRACT

A mechanism for precisely filling containers such as plastic bags with cooked food to be frozen later is disclosed. The mechanism includes a base and a funnel. The base includes a planar portion for mounting upon a flat surface and a hollow sleeve unitary with and oriented transverse to the planar portion. The sleeve is hollow and is sized to contain a container such as a plastic bag. The funnel has an inlet portion into which cooked food is introduced, an outlet portion sized to be insertable into a container such as a plastic bag, and a flange unitary with the inlet and outlet portions. An inner surface of the inlet portion includes a fill line, for enabling the container to be precisely filled with cooked food.

This nonprovisional patent application is based on provisional application U.S. Ser. No. 63/367,533 filed Jul. 1, 2022; incorporated by reference in its entirety for priority purposes.

### FIELD

The present subject matter, directed in general to a mechanism for precisely filling containers, is more particularly directed to a mechanism for precisely filling plastic bags.

### BACKGROUND

Storing food in resealable plastic bags has come into wide use. Resealable plastic bags are usually rectangular in shape with a sealable open edge defining spaded-apart edge margins having interlocking male-and-female tracks or zippers. One problem is that the seals are not necessarily airtight. Another problem occasionally experienced, when sealed storage bags are frozen, is that closures are less resilient (when frozen), resulting in seals possibly becoming “broken open” when adjacent frozen foods are re-arranged.

While most resealable storage bags on the market today are waterproof when sealed and appear to be airtight, when stored for extended periods of time, air may still penetrate the seals, creating frost which causes freezer burn. Freezer burn on food stored in plastic resealable storage containers for lengthy periods continues to pose a problem.

The “freezer burn” problem is amplified when modern refrigerators equipped with “frost-free” freezer compartments are found in homes, because a periodic warming cycle, used to melt frost, then re-freezes the water, allowing additional ice to accumulate in bags.

For various reasons, many people (and assorted food-processing companies) use large cooking pots (including industrial-sized cooking vessels) to prepare stews, sauces soups, chili, and so forth, either for very large gatherings or with the intention of freezing much of the cooked food in smaller—e.g., quart or gallon—portions for meals to be eaten later. One problem experienced when rigid containers store frozen food is the freezer burn problem noted. Another problem occasionally experienced with rigid containers when filled containers don't allow for expansion of contents (as hot food begins to freeze), is a failure of a lid to seal, or a “splitting” of a container when the container lid is tightly on.

As a result, many preparers of large quantities of cooked food for later storage in a freezer would like to avoid freezer burn experienced from underfilling containers with cooked food as well as the mess that results from overfilling containers with cooked food.

The present subject matter enables such people and the public at large, including food processing companies that prepare large quantities of cooked food for later storage in a freezer, to avoid freezer burn and the mess that results from overfilling the containers.

### SUMMARY

In accordance with the present subject matter, a mechanism or device to fill containers (e.g., quart-sized containers, gallon-sized containers, etc.) with hot, cooked food for subsequent freezing of the hot food-filled containers, shall now be summarized.

The present subject matter, a mechanism or device for precisely filling containers with cooked food to be frozen, includes a base and a funnel. The base includes a planar portion and a hollow sleeve portion which is unitary with the planar portion. The planar portion is mountable upon a surface, such as an upper surface of a table. The sleeve, oriented transverse to the planar portion, has an upper edge margin. The sleeve includes an internal region configured and dimensioned to contain a container that has an opening.

The funnel includes an inlet portion into (and through) which cooked food (to be frozen) is introduced. The funnel also includes an outlet portion unitary with the inlet portion. The funnel outlet portion is configured and dimensioned for removable insertion into a container open end portion (or opening) for enabling cooked food to be introduced into and contained within the container. The funnel further includes a flange unitary with the inlet and outlet portions of the funnel. The flange is flat to mount upon an upper surface of the sleeve after the funnel outlet portion is inserted through a container opening and the container inserted into the sleeve. The flange extends laterally outwardly from the funnel inlet and outlet portions by a distance effective for enabling the sleeve upper edge to support the flange. A container is thus supported within the internal region of the sleeve, to enable container to be filled, precisely, to a predetermined level with the cooked food.

### BRIEF DESCRIPTION OF THE FIGURES

FIG. 1 is an upper perspective view of an embodiment of the present subject matter.

FIG. 2 is an exploded, frontal view of the two-piece embodiment depicted in FIG. 1.

FIG. 3 is an exploded view of a three-piece embodiment of the present invention.

FIG. 4 is a partially assembled, front elevational view of the embodiment of FIG. 3.

FIG. 5 is an assembled, front elevational view of the present subject matter in use.

FIG. 6 depicts a now filled container, separated from components of the invention.

FIG. 7 illustrates yet another two-piece embodiment of the present subject matter.

FIG. 8 presents a partially exploded, front view of the embodiment shown in FIG. 7.

Throughout FIGS. described above and the following detailed description, similar reference numerals are used to refer to similar components of the present subject matter.

### DETAILED DESCRIPTION

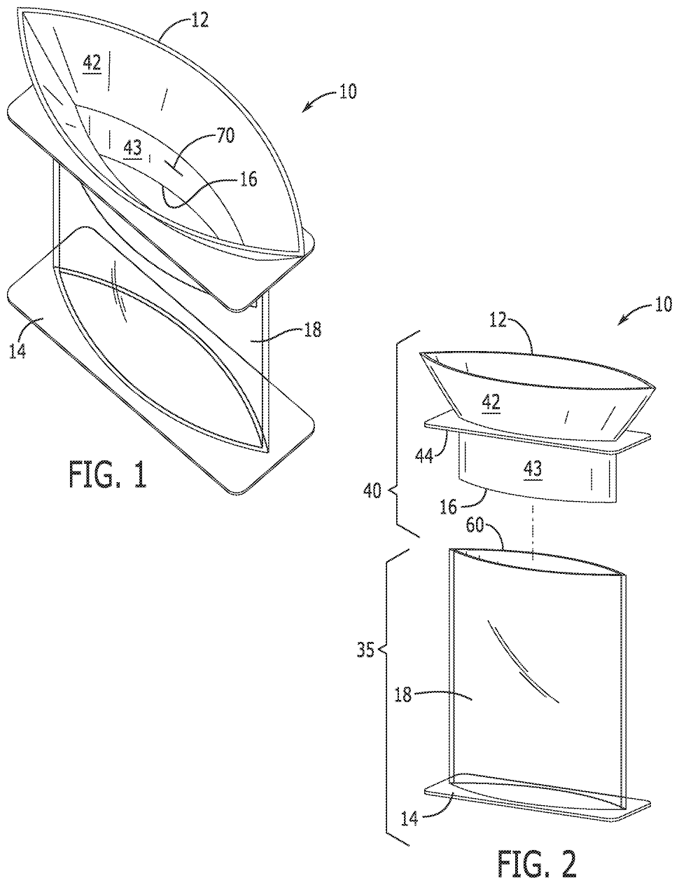

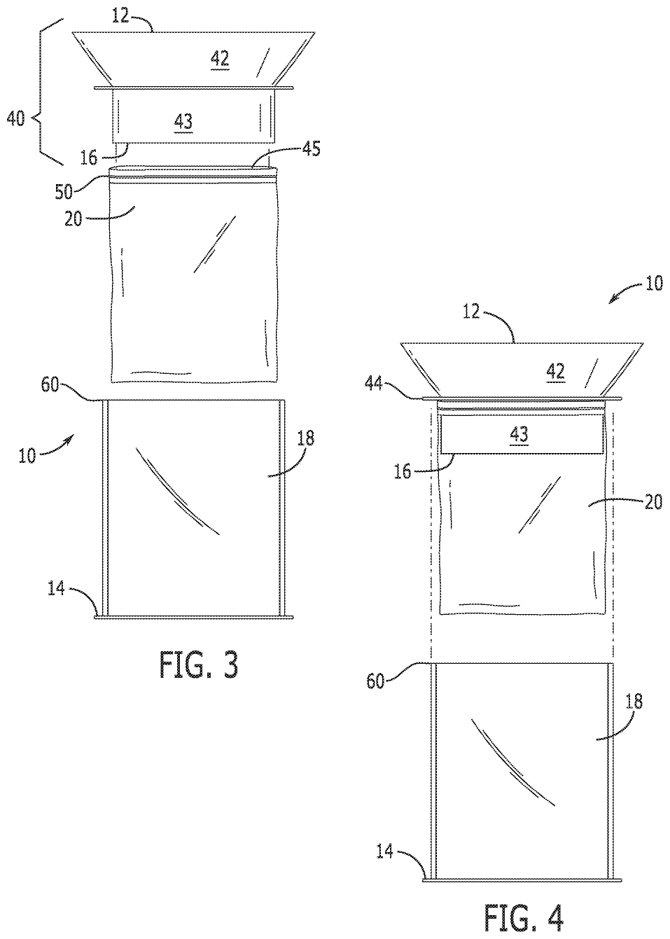

One embodiment of the present subject matter is directed to a two-component mechanism or device 10 (see FIGS. 1, 2) designed, sized, and configured to precisely fill a container 20 (FIGS. 3, 4)—e.g., bag, envelope, pouch, sack, sleeve, etc.—with food for future consumption. More particularly, containers 20 of predetermined wall thickness and volumetric capacity (e.g., quart-size containers, gallon-size containers) are precisely filled with the cooked food for purposes of freezing the precisely filled food containers 20.

The present subject matter, a mechanism or device 10, which is designed to be used to precisely fill containers 20 with cooked food (often still hot) to be frozen, includes a base 35 portion and a funnel 40 portion. (FIG. 2.) The base 35 consists essentially of a planar portion 14 and a hollow sleeve 18 portion that is unitary with the planar portion 14. The planar portion 14 is sized and adapted to be placed firmly upon a horizontal surface (e.g., an upper surface of a table, a countertop, an upper surface of a stove or oven). The sleeve 18, oriented transverse to planar portion 14, has an open upper-edge margin 60.

The hollow sleeve 18 defines an internal region sized and configured to encircle a container 20 (FIGS. 3, 4) having an opening 45 at one end portion. Adjacent the opening is an openable and re-sealable sliding plastic zipper 50 (FIG. 3) based in part upon U.S. Pat. No. 2,613,421 to Madsen and U.S. Pat. No. 5,403,094 to Tomic, each of which is incorporated by reference in its entirety. The container 20, preferably a plastic bag for aseptic packaging of food products, is based in part on U.S. Pat. No. 3,986,661 to Johnson, incorporated by reference in its entirety. Additional design features of the bag or container of the present subject matter are described in detail in this patent specification. For instance, to avoid freezer burn, it might become necessary for the plastic zipper 50 to incorporate additional elements integral with a plastic bag or container 20, such as interlocking rib-and-groove elements disclosed in U.S. Reissue Pat. No. 28,969 to Naito and U.S. Pat. No. 4,212,337 to Kamp, each of which is incorporated by reference in its entirety.

The funnel 40 (FIG. 2) consists essentially of an upper portion 42, a lower portion 43, and an intermediate portion or flange 44 between and unitary with the upper and lower portions 42 and 43 of the funnel 40. The lower portion 43 of the funnel 40 is dimensioned and configured to fit through the opening 45 (FIG. 3) of a container 20 through which cooked food, often hot, passes. (FIGS. 3-5.) The flange 44 of the funnel 40 is sized and shaped to be flatly supported upon an upper surface of the open-end edge margin 60 (FIGS. 2-6) of the hollow sleeve 18. A bottom edge 16 of the lower portion 43 is open (FIG. 1) while a top edge 12 of the upper portion 42, also open, extends upwardly and away from the lower portion 43, so that the upper portion 42 defines a quasi-frustoconical section (FIG. 1), with the top edge 12 defining a larger opening than the bottom edge 16.

Embodiments of the base 35 and funnel 40 portions (FIG. 2) of the mechanism or device 10 described above are preferably dimensioned, adapted, and configured to be used in connection with bags or containers 20 having a volumetric capacity of about 950 milliliters which a person of ordinary skill in the art (POSITA) knows is about one US quart.

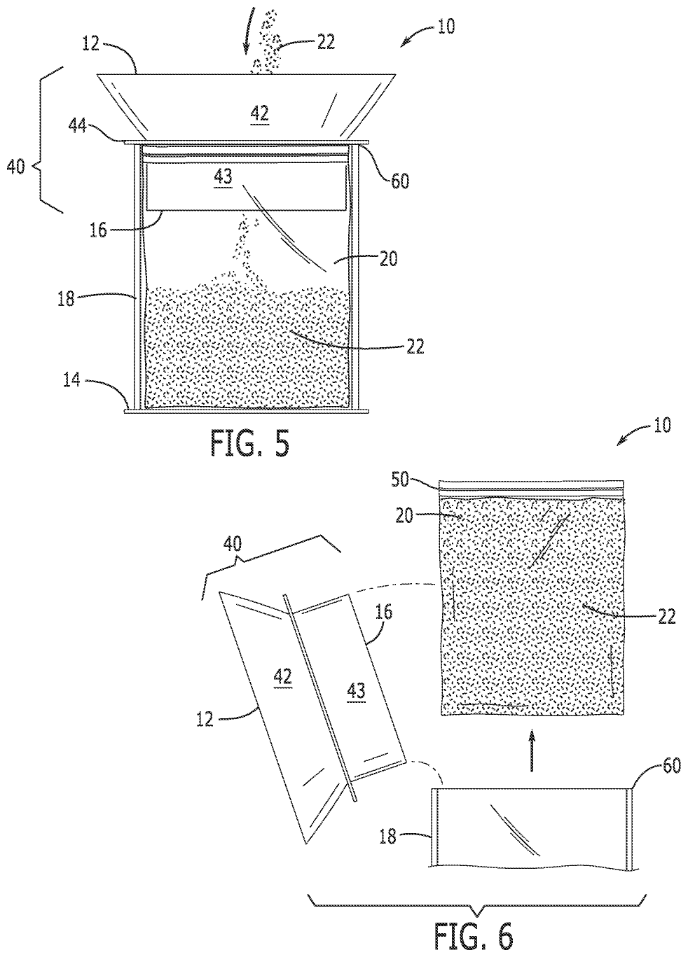

To achieve assembled operation, the bottom edge 16 of the lower portion 43 of the funnel 40 is first disposed through the opening 45 of the 950-milliliter (one quart) bag or container 20 (FIGS. 3-4). Thereafter, the bag or container 20 is disposed through the open-end edge margin 60 of the sleeve 18 and then into its hollow interior (FIGS. 4-5). Next, cooked food 22 (of predetermined particle size) is introduced into the upper portion 42 of the funnel 40, and passed through the lower portion 43, to collect within the bag or container 20, as shown in FIG. 5. As soon as a level of cooked food 22 filling the bag or container 20 reaches a predetermined fill line 70 (FIG. 1), transfer of cooked food 22 into funnel 40 ceases. Then, the funnel 40 is removed from bag or container 20; next, the bag or container 20 is removed from hollow sleeve 18 (FIG. 6); and air above the cooked food 22 is removed, while the sliding plastic zipper 50 is used to seal the bag or container 20.

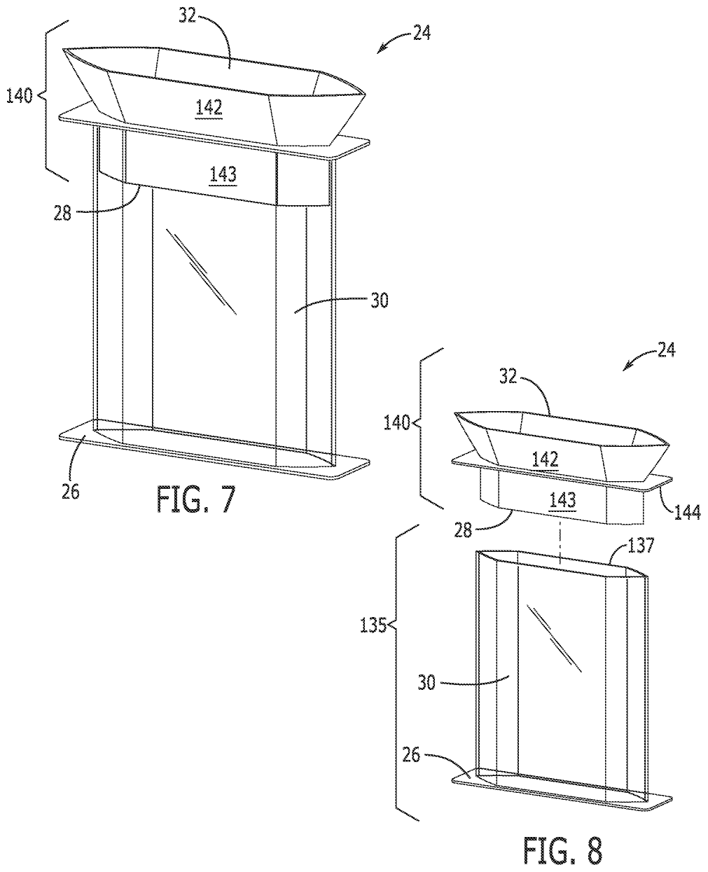

A second embodiment 24 of the present subject matter is shown in FIGS. 7 and 8. Bags or containers used in connection with the second embodiment 24 have a volumetric capacity of about 3.8 liters, which a person of ordinary skill in the art knows is about one US gallon. The second embodiment 24 is also designed to be used to precisely fill bags or containers with cooked food (often hot) to be frozen later. A mechanism or device of the second embodiment 24 includes a base 135 and a funnel 140. The base 135 consists essentially of a planar portion 26 and a hollow sleeve 30 unitary with the planar portion 26. The planar portion 26 is sized and adapted to be placed firmly on a horizontal surface (e.g., an upper surface of a table, a countertop, an upper surface of a stove or oven). The sleeve 30, oriented transverse to planar portion 26, has an open upper-edge margin 137.

The second embodiment 24, with its own fill line (not shown), is similarly used to precisely fill 3.8-liter (one-gallon, US) bags or containers with cooked food. Additional embodiments could be made to fill larger or smaller bags or containers. The funnel 140 consists essentially of an upper portion 142, a lower portion 143, and an intermediate portion or flange 144 between and unitary with the upper and lower portions 142 and 143 of the funnel 140. The lower portion 143 of the funnel 140 is sized and configured to fit into the opening of a 3.8-liter bag or container (not show) into (and through) which cooked (often hot) food (to be frozen) passes for containment within the bag or container. The flange 144 of the funnel 140 is dimensioned and configured to be flatly supported upon an upper surface of the open-end edge margin 137 of the hollow sleeve 30. A bottom edge 28 of the lower portion 143 of the funnel 140 defines an outlet. A top edge 32 of the upper portion 142 of the funnel 140 defines an inlet. Sides of the upper portion 142 extend upwardly and away from the flange 144, so that the upper portion 142 defines an upwardly disposed, outwardly expanding section (the embodiment shown in FIGS. 7,8 is six-sided), with the top edge 32 of the funnel 140 defining a larger opening than its bottom edge 28.

### INDUSTRIAL APPLICABILITY

The base and funnel components of the mechanism or device of the embodiments of the present subject matter could be manufactured from an assortment of commercially available and suitable, food-grade polymeric or various other suitable materials. For instance, conventional injection-molding machines could be used to manufacture base and funnel components from select food-grade polymeric materials.

Illustrated and described in this patent specification is a mechanism or device for precisely filling containers with cooked food. While the present subject matter has been illustrated and described in relation to two embodiments, the present subject matter is not limited only to these embodiments. On the contrary, many alternatives, changes, and/or modifications will become apparent to a person of ordinary skill in the art (POSITA) after reading this patent specification in connection with its drawing figures. Therefore, all such alternatives, changes, and modifications are to be viewed as forming a part of the present subject matter insofar as they fall within the spirit and scope of the appended claims.

I claim:

1. A mechanism for precisely filling containers with cooked food to be frozen, comprising:
a base (35) consisting essentially of:
a planar portion (14) mountable upon a surface, and
a hollow sleeve (18) unitary with and oriented transverse to the planar portion (14), wherein the sleeve (18) has an upper edge margin (60) and includes an internal region dimensioned and configured for containing a hollow container (20) having an opening (45); and
a funnel (40) consisting essentially of:
an inlet portion (42) into which cooked food to be frozen is introduced,
an outlet portion (43) dimensioned and configured to be removably disposable through the container opening (45) for enabling cooked food to be introduced into and contained within the container (20), and
a flange (44) between and unitary with the inlet and outlet portions (42, 43),
wherein the container (20) is removably disposed within the sleeve (18), wherein the outlet portion (43) is removably disposed through the container opening (45), and wherein an inner surface of the outlet portion (43) includes a fill line (70), for enabling the container (20) to be filled precisely to a predetermined level with cooked food to be frozen.

2. The mechanism of claim 1, wherein the funnel (40) has a top edge (12) and a bottom edge (16), and wherein the funnel inlet portion (42) defines a quasi-frustoconical side section, so that the top edge 12 defines a larger opening than the bottom edge 16.
